(19) United States
(12) Patent Application Publication
(10) Pub. No.: US 2022/0337127 A1
(43) Pub. Date: Oct. 20, 2022

(54) STATOR

(71) Applicant: ebm-papst Mulfingen GmbH & Co. KG, Mulfingen (DE)

(72) Inventors: Michael STURM, Bad Mergentheim (DE); Werner MÜLLER, Mulfingen (DE)

(21) Appl. No.: 17/720,915

(22) Filed: Apr. 14, 2022

(30) Foreign Application Priority Data
Apr. 16, 2021 (DE) 10 2021 109 663.4

(51) Int. Cl. H02K 9/22; H02K 1/14; H02K 9/20

(52) U.S. Cl. CPC H02K 9/225; H02K 1/146; H02K 9/20

(57) ABSTRACT

Stator, in particular a stator manufactured from punch bundled dynamo sheets, for an external rotor and/or an internal rotor motor of an electric machine, comprising a stator yoke, a plurality of stator teeth, as well as in each case one stator groove lying between two stator teeth, wherein at least one heat conducting pipe for cooling the stator is in each case incorporated in the stator groove.

### CROSS-REFERENCE TO RELATED APPLICATION

This application claims the benefit of German Application No. 10 2021 109 663.4, filed Apr. 16, 2021, the contents of which is hereby incorporated by reference in its entirety, further the entirety of the attached translation of German Application No. 10 2021 109 663.4 is incorporated by reference.

### FIELD OF THE DISCLOSURE

The present disclosure relates to a stator.

### BRIEF SUMMARY

A stator for an external rotor and/or an internal rotor motor of an electric machine, the stator includes a stator yoke, a plurality of stator teeth, as well as in each case one stator groove lying between two stator teeth, wherein at least one heat conducting pipe for cooling the stator is in each case incorporated in the stator groove.

### BRIEF DESCRIPTION OF THE DRAWINGS

FIG. 1 shows a perspective exploded drawing of a stator of an external rotor electric motor, having heat conducting pipes; and

FIG. 2 shows a fragmented close-up view of a perspective illustration of an external rotor electric motor having a heat conducting pipe and holding tabs.

### DETAILED DESCRIPTION

Stators of this type heat up by virtue of the electromagnetic interactions acting on said stators during operation. This heat generated has to be dissipated and the stator has to be adequately cooled with a view to an optimal operation. Various solutions to this end are already known from the prior art.

For example, GB 2 585 576 A discloses a stator of an external rotor motor, wherein the stator supports a plurality of field coils, and at least one heat conducting means lies at the end side of at least one field coil, or on a casting compound or an isolator surrounding the field coil, and for dissipating the heat is furthermore connected to a cooling member, in particular in the form of the stator support, the cooling member and/or the housing.

In systems of this type it is disadvantageous that the incorporation of the cooling means in the stator is associated with a disturbance of the magnetic flux within the stator, this leading to a reduction in terms of the output potential of the electric machine.

Therefore, it is an object of the present disclosure to propose a possibility for cooling a stator of an electric machine, for example of an electric motor, in which a higher efficiency of the electric machine is achieved.

This object is achieved according to the present disclosure.

The present disclosure describes a stator, in particular a stator manufactured from punch bundled dynamo sheets, for an external rotor and/or an internal rotor motor of an electric machine, comprising a stator yoke, a plurality of stator teeth, as well as in each case one stator groove lying between two stator teeth, characterized in that at least one heat conducting pipe for cooling the stator is in each case incorporated in the stator groove.

In order for the thermal management of the stator to be optimized, easy and rapid fitting of the heat conducting pipes to a, for example already prefabricated, stator can advantageously made possible in this way. Because said stator during production, for example in large volumes and depending on the requirement, may have different lengths, this enables the required heat conducting pipes to be individually adapted to the individual stator. The shape of the stator can thus be chosen independently of the heat conducting pipes, and optimizing the magnetic flux within the stator can be achieved without the latter being affected by the heat conducting pipes. High filling levels of the stator groove by electric windings can be achieved as a result of a possibility for a compact construction mode being generated in this manner.

It is furthermore provided that the heat conducting pipe is at least partially recessed in an envelope of the stator groove.

As a result, the heat conducting pipe can be reliably held on the stator and shifting of said heat conducting pipe can be prevented in the manufacturing process. This enables more precise manufacturing which is improved in terms of the error-proneness of the latter, this potentially reducing costs during production.

It is moreover provided that, when viewed in the radial direction towards the stator, the heat conducting pipe, preferably in an up-and-down movement, encloses in each case at least one stator tooth.

As a result, the spatial proximity to the source of the heat generation within the stator is reduced, and a cost-effective and material-saving production of the heat conducting pipes is made possible. As a result, production costs can be reduced.

It is furthermore provided that the heat conducting pipe is configured in such a manner that the heat arising during the operation of the stator is guided to a point remote from the stator.

A space-saving construction of the stator can be enabled as a result, and further systems for dissipating heat outside the stator, for example cooling ribs in the region of a flange of a stator bush, can be installed. An improved possibility for a surrounding flow of air at points remote from the stator can be utilized, for example. This can have an advantageous effect with a view to a more compact construction of the electric machine, for example an electric motor.

It is moreover provided that the heat conducting pipe is held in position by means of holding tabs.

Holding tabs can advantageously improve the three-dimensional fixing of the heat conducting pipes, this potentially simplifying and accelerating the production process. This can be advantageously utilized for reducing production costs, and be positively utilized for quality control purposes.

It is furthermore provided that the holding tabs are configured as an insert component, in particular a separate insert component.

Separate insert components make modular manufacturing possible, this potentially making possible higher flexibility in terms of production with a view to different stator construction lengths. As a result, a greater bandwidth of constructions desired according to the respective requirement can be achieved when proceeding from prefabricated modules.

It is moreover provided that one holding tab holds in each case one first as well as one second heat conducting pipe at opposite ends of the holding tab.

Reliable mounting of the heat conducting pipes as well as faster assembling of the stator can advantageously be enabled as a result. Moreover, material can be saved in the production of the holding tabs in this way, this potentially having an advantageous effect on the production costs.

It is furthermore provided that the heat conducting pipe is held in position by means of at least one, preferably two, winding members.

It is advantageous here that existing elements of the stator can be utilized for guaranteeing reliable mounting of the heat conducting pipes. This can manifest itself in the form of a simpler construction, or in more favourable costing, respectively.

It is moreover provided that the heat conducting pipe is held in position by holding tabs that are disposed on, preferably fastened to, a/the winding member(s).

This can advantageously be utilized for improving the mounting of the heat conducting pipes in the desired position of the latter.

In the context of the present disclosure, a heat conducting pipe is also understood to be a thermal pipe, a heat pipe, or comparable systems which, driven by gravity and by means of the evaporation heat of a medium, in the interior thereof utilize a high thermal flow density.

Furthermore, in the context of the present disclosure a winding member is understood to be, for example, a component which is prefabricated from a plastics material and which comprises a winding for operating the electric machine, for example a motor, and in a modular manner can be pushed onto a prefabricated stator.

Further details of the present disclosure will be described in the drawings by means of schematically illustrated exemplary embodiments.

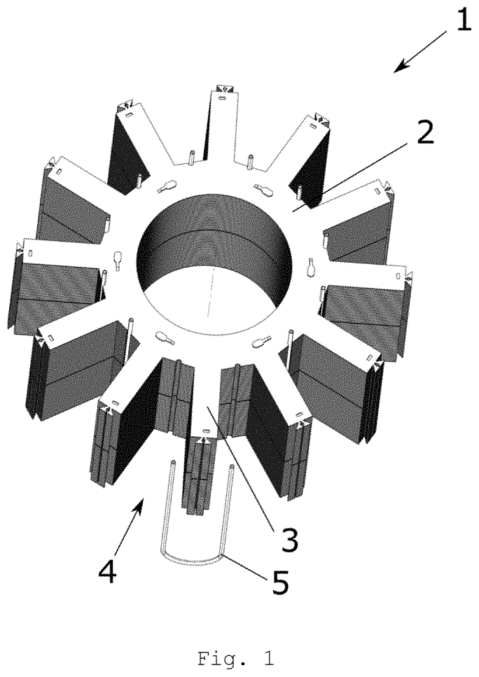

A perspective exploded drawing of a stator 1 of an external rotor electric motor having heat conducting pipes 5 is illustrated in FIG. 1. The stator 1, manufactured from punch bundled dynamo sheets, of an electric machine comprises a stator yoke 2, a plurality of stator teeth 3, as well as in each case one stator groove 4 lying between two stator teeth 3, wherein at least one heat conducting pipe 5 for cooling the stator 1 is incorporated in the stator groove 4. The heat conducting pipes 5 are at least partially recessed in an envelope of the stator groove 4 and, when viewed in a radial direction towards the stator 1, the heat conducting pipe 5, in an up-and-down movement, as illustrated here in a U-shaped manner, encloses the stator tooth 3. In one preferred embodiment it is provided that the heat conducting pipe 5 guides the heat arising during the operation of the stator 1 to a point remote from the stator (not illustrated). As a result, it is made possible that the magnetic flux within the stator 1 is barely disturbed by the heat conducting pipe 5, and the thermal management of the stator 1 can be optimized. Compact construction modes can be made possible as a result, and a high filling level can be achieved, especially in the case of modular manufacturing methods and for example when different construction lengths of the stators 1 to be manufactured arise.

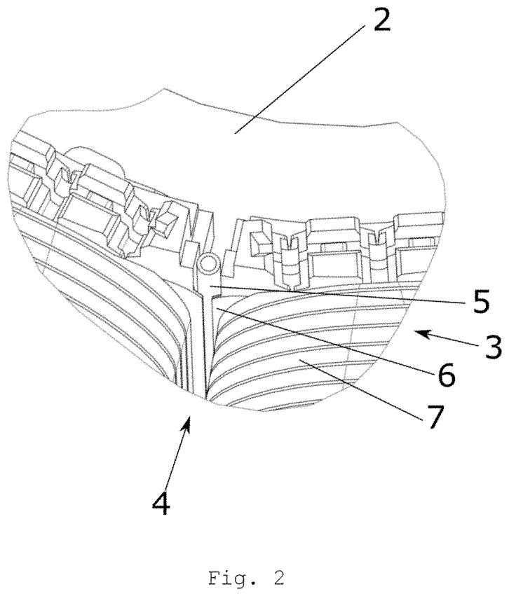

It is illustrated in FIG. 2, and also when viewed in combination with FIG. 1, that the heat conducting pipe 5 is held in position by means of holding tabs 6. The holding tabs 6 are configured as a separate insert component, and in one particular embodiment it is provided that one holding tab 6 holds in each case one first as well as one second heat conducting pipe 5 at opposite ends of the holding tab 6 (not illustrated). It is likewise illustrated that the heat conducting pipe 5 by means of two winding members 7 is held in position so that the heat conducting pipe 5 is held in position by a holding tab 6 that is disposed on and fastened to the winding members 7. The holding tabs 6 can guarantee optimal mounting of the heat conducting pipes 5, and simple fitting can be made possible as a result. For example, in the case of tooth shoe which is configured so as to be releasable, or as a separate component, such as is known from document 10 2021 109 653.7 filed with the German Patent and Trademark Office on 16 Apr. 2021 by the same applicant, the individual components can be easily connected to one another. This reference to the parallel application replaces the description and potential drawings of such a tooth shoe in this application. A rapid and cost-saving production of the electric machine can thus be achieved.

Although the present invention has been described with reference to preferred embodiments, workers skilled in the art will recognize that changes may be made in form and detail without departing from the spirit and scope of the invention.

### LIST OF REFERENCE SIGNS

1 Stator
2 Stator yoke
3 Stator tooth
4 Stator groove
5 Heat conducting pipe
6 Holding tab
7 Winding member

What is claimed is:

1. A stator for an external rotor and/or an internal rotor motor of an electric machine, the stator comprising:
a stator yoke, a plurality of stator teeth, as well as in each case one stator groove lying between two stator teeth,
wherein at least one heat conducting pipe for cooling the stator is in each case incorporated in the stator groove.

2. The stator of claim 1, wherein the heat conducting pipe is at least partially recessed in an envelope of the stator groove.

3. The stator of claim 1, wherein, when viewed in the radial direction towards the stator, the heat conducting pipe encloses in each case at least one stator tooth.

4. The stator of claim 3, wherein, when viewed in the radial direction towards the stator, the heat conducting pipe, in an up-and-down movement, encloses in each case at least one stator tooth.

5. The stator of claim 1, wherein the heat conducting pipe is configured in such a manner that the heat arising during the operation of the stator is guided to a point remote from the stator.

6. The stator of claim 1, wherein the heat conducting pipe is held in position by holding tabs.

7. The stator of claim 1, wherein the holding tabs are configured as an insert component.

8. The stator of claim 7, wherein the holding tabs are configured as a separate insert component.

9. The stator of claim 1, wherein one holding tab holds in each case one first as well as one second heat conducting pipe at opposite ends of the holding tab.

10. The stator of claim 1, wherein the heat conducting pipe is held in position by at least one winding member.

11. The stator of claim 10, wherein the heat conducting pipe is held in position by two winding members.

12. The stator of claim 11, wherein the heat conducting pipe is held in position by holding tabs that are disposed on the at least one winding member.

13. The stator of claim 11, wherein the heat conducting pipe is held in position by holding tabs that are fastened to the at least one winding member.

14. The stator of claim 1, wherein the stator comprises a stator manufactured from punch bundled dynamo sheets.
